(19) United States
(12) Patent Application Publication
(10) Pub. No.: US 2022/0043443 A1
(43) Pub. Date: Feb. 10, 2022

(54) Smart Navigation System

(71) Applicant: Passion Mobility Ltd., Taipei City (TW)

(72) Inventor: Chung Hsin Lee, Las Vegas, NV (US)

(21) Appl. No.: 16/984,295

(22) Filed: Aug. 4, 2020

(51) Int. Cl. G05D 1/00; G05D 1/12; G05D 1/02; G06F 3/01; G06F 3/16; G06K 9/00; G06N 20/00

(52) U.S. Cl. CPC G05D 1/0016; G05D 1/12; G05D 1/0234; G05D 1/0274; G06N 20/00; G06F 3/017; G06F 3/167; G06K 9/00362; G06K 9/00355; G05D 1/0094

(57) ABSTRACT

A smart navigation system of an automated guided vehicle, the smart navigation system having multiple operation modes and the automated guided vehicle switching between these operation modes comprising 1) follow operator, 2) follow markings, 3) follow operator and markings, 4) follow a map, wherein the automated guided vehicle perform the modes about following the operator by capturing images of a geographic area, the automated guided vehicle identify a operator in the images and records movements and gestures thereof to switches between the operation modes.

### FIELD OF THE INVENTION

The present invention relates to navigation system, and more particularly to navigation system with variant navigation functions being able to switch intelligently.

### BACKGROUND OF THE INVENTION

Automated guided vehicles (AGVs) have been widely used in indoor environments such as warehouses and manufacturing floors, or outdoor environments such as resorts, for a long period of time, and has brought countless advantageous such as saving manpower, extensive amount of time and providing high reliability. These AGVs are often predefined to be navigated by one of the various types of navigation methods, such as Global Positioning System (GPS) in outdoor environments, or using physical markers deployed on the floor for guiding automated guided vehicles maneuvering in either outdoor or indoor environments.

For automatic guided vehicle system (AGV), the navigation method is a very important consideration. Because of the different surrounding layouts, the AGV vendors and users will need to figure out what kind of navigation method is best suited for this specific task. Most of the present day navigation methods are designed for single method application. It is not easy to convert to a different navigation method for AGV systems because the working area need to be prepared for particular type of navigation system.

Furthermore, a practical environment that AGVs being operated changes frequently by different unexpected circumstances, such like unexpected obstacles, collisions, other AGV idle or disconnected and etc. The aforementioned AGVs are not able to operate in the environment with unexpected changes.

### SUMMARY OF THE INVENTION

In accordance with the above shortcomings, an smart AGV navigation system that can navigate AGVs in environment having variant circumstances, the AGVs may switch to a suitable operation mode according to the requirement of the AGV to finish requested tasks.

The present invention provides a smart navigation system of an automated guided vehicle, the smart navigation system having multiple operation modes and the automated guided vehicle switching between these operation modes comprising 1) follow operator, 2) follow markings, 3) follow operator and markings, 4) follow a map, wherein the automated guided vehicle perform the modes about following the operator by capturing images of a geographic area, the automated guided vehicle identify a operator in the images and records movements and gestures thereof to switches between the operation modes.

wherein, a controller connected to the processor, and a sensor system connected to the processor configured to control the automated guided vehicle between stations, wherein the sensor system detects images with human features and environment features, the human features comprises operator identity, human form, the gestures and vocal commends, the environment features comprises markings and tags, the controller operates the sensor system to continuously captures the images and the processor identify the human features and the environment features from these images, the controller switches to another operation mode while a pre-defined character in the automated guided vehicle being identified by the processor.

wherein, the smart navigation system of an automated guided vehicle having an image database being connected to the controller, wherein the image database stores characters of the human features and the environment features, the processor identifies characters in the captured images, thus the controller tracks the characters of the human features and the environment features to adjust a moving route of the automated guided vehicle.

wherein, the smart navigation system of an automated guided vehicle having a machine learning unit being connected to the controller, the machine learning unit records the characters of the detected environment features and the human features.

wherein, the automated guided vehicle is moved according to a pre-loaded map.

wherein, the automated guided vehicle is interrupted to adjust a prior route as another new operation mode corresponding to a location of the operator and markings.

As described above, the uniqueness of this system are the followings:

1. The present invention allows different navigation methods to be implemented concurrently or sequentially in a single task without hardware changes and with or without operator's input.

2. It recognizes the operator and he operator's gestures so the vehicle can switch to different navigation methods such as following the operator, following the floor marking, follow both operator and floor marking, and following prescribed paths as stored in the system.

3. The AGV can navigate the work area with minimum preparedness and is very flexible in moving around with the operator's body command and gestures

### BRIEF DESCRIPTION OF THE DRAWINGS

The structure and the technical means adopted by the present invention to achieve the above and other objects can be best understood by referring to the following detailed description of the preferred embodiments and the accompanying drawings.

FIG. 1 is a schematic diagram illustrating an automated guided vehicle of a navigation system according to an embodiment of the present invention; and

FIG. 2 is a flow chart illustrating a operation mode changing method of the navigation system according to an embodiment of the present invention.

### DETAILED DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts. It is not intended to limit the method or the system by the exemplary embodiments described herein. In the following detailed description, for purposes of explanation, numerous specific details are set forth in order to attain a thorough understanding of the disclosed embodiments. It will be apparent, however, that one or more embodiments may be practiced without these specific details. As used in the description herein and throughout the claims that follow, the meaning of “a”, “an”, and “the” includes reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to. As used in the description herein and throughout the claims that follow, the meaning of “in” includes “in” and “on” unless the context clearly dictates otherwise.

It will be understood that when an element is referred to as being “connected” to another element, it can be directly connected to the other element or intervening elements may be present.

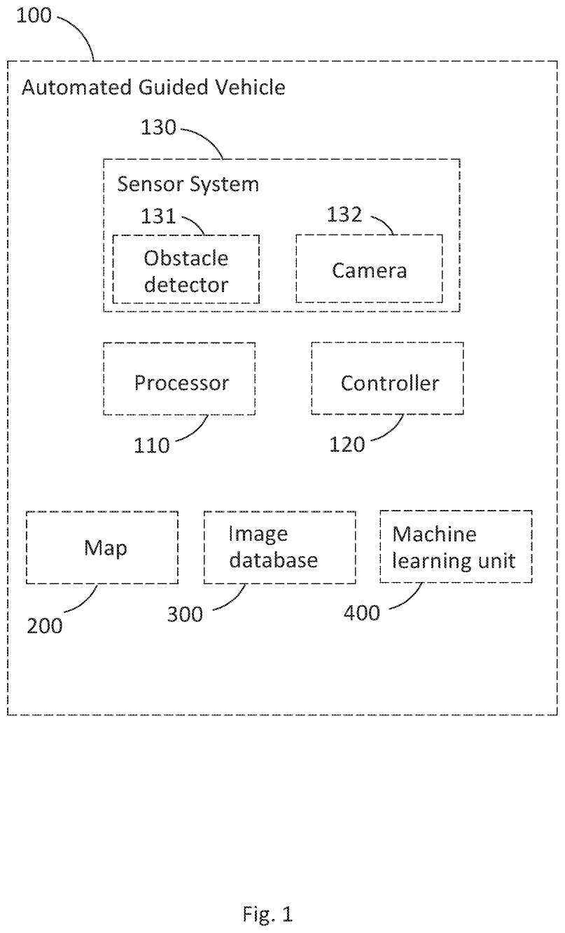

With reference to FIG. 1, a smart navigation system in accordance with the present invention is applicable to an automated guided vehicle (AGV) 100 and may optionally includes a number of stations deployed about a geographic area in the present embodiment. These stations may be shelves or predefined locations that AGV 100 may be asked to access and finish pre-loaded tasks. The smart navigation system for the AGV 100 has multiple operation modes, the AGV 100 may be operated between these modes according to a status of the geographic area.

The navigation system includes at least one AGV 100 capable of traveling within the geographic area. The AGV 100 includes a processor 110, a controller 120 connected to the processor 110, and a sensor system 130 connected to the processor 110 configured to control the AGV 100 to travel between stations in the geographic area. Said stations may be a shelf, a GPS spot, a location of an electronic tag and/or the like.

The AGV 100 is controlled by the controller 120 that is interoperable with the processor 110 in conjunction with the sensor system 130. The sensor system 130 is capable of detecting images with human features and environment features. The said human features may comprise an operator's identity, a human form, gestures, vocal commends or the like. The operator's identity may be a tag mounted on the operators so that the sensor system 130 is capable of detecting the operator, the tag may be passive or active electronic tag carried by the operator. The human form can be a skeleton of a human, a body temperature or the like. The gestures may be a lifted arm with certain angle, a movement of the operator and/or the like. Different gesture can be used to providing new instruction to the AGV 100, thus the AGV 100 changes the operation mode in the geographic area. The operation mode of the AGV 100 may also be changed according to the vocal commend of the operator, the AGV 100 is interrupted and switched to another operation mode by specific vocal commend from the operator.

It is worth mentioning that the sensor system 130 also includes an obstacle detector 131 connected to the processor 110 and capable of detecting any obstacle existing on the predetermined traveling route.

The smart navigation system may also include a number of reference units (not shown) deployed within the moving path along the predetermined traveling route, where the sensor system 130 may include an optical sensor configured to detect the reference units. More specifically, in response to detecting one of the reference units by the sensor system 130 closest to the AGV 100 along the predetermined traveling route, the AGV 100 moves toward the reference unit for adjustment of its current movement, so that the AGV 100 can stay on track. Each of the reference units can be made of reflective materials, and the sensor system 130 may include a camera 132 capable of detecting the reference units. Furthermore, the camera 132 may also be utilized for assisting the AGV 100 to maintain its path along the predetermined traveling route toward the next station along the predetermined traveling route. Specifically, the camera 132 is interoperable with the processor 110 for determining a center line of the station that the AGV 100 is heading to from the at least one of the images continuously captured by the camera 132 with a predetermined image capturing rate while the AGV 100 travels from one stations to one another, and at least one of the captured images shows the station which the AGV 100 is heading to.

The navigation system may also includes a map 200. The map 200 is accessible by the AGV 100. In other words, the map 200 can be remotely accessed by the AGV 100; alternatively, the map 200 can be stored in a memory unit (not shown) connected with the processor 110 thereby being access by the processor 110 directly. The map 200 includes a coordinate of each of the stations within the geographical area. The processor 110 of the AGV 100 is configured to receive a task command by the AGV 100, where the task command may be sent from the operator and includes the coordinate of the stations to be finally reached. More importantly, the map 200 includes a path parameter defining the moving path between each two of the stations, i.e. between the start station and the checkpoint station, or between the checkpoint station and the end station.

In addition, the path parameters may be obtained while approaching any station where the AGV 100 may retrieve such information by wireless means. In some embodiments, the path parameter can be obtained from the map 200 and the task command as well. The processor 110 of the AGV 100 is also configured to identify the closest station from the AGV 100 to be the start station in reference with the map 200, so that it is ensured that while the AGV 100 receives the task command, it starts maneuvering from the start station. While the start station is identified, the processor 110 may control the AGV 100 to approach the start station by commanding the controller 120 of the AGV 100. The start station may also be verified with an identity information acquired by retrieving data from an identity tag ID disposed on each of the stations while the AGV 100 moves close to the start station. The identity tag can be a QR code, an RFID tag, an NFC tag, or their combinations.

The processor 110 is further configured to calculate and determine the predetermined traveling route, and to determine, with the sensor system 130 of the AGV 100, whether a physically marked line such as a colored tape, a magnetic tape or the like, is detected. In response to determining that the marked line is detected, the controller 120 controls the AGV 100 to travel along the predetermined traveling route by referencing the marked line, and in response to determining that no marked line is detected, controlling the AGV 100 to travel along the predetermined traveling route by moving within the moving path between the stations with reference to the path parameters. The moving path is a virtual path and is preferably utilized while no marked line has been detected. Each of the path parameters include identities of two of the stations respectively located at both ends of the moving path, heading angle information to travel between the two stations, and a predetermined distance and a predetermined width of the moving path connecting the two stations.

What is more, the images captured by the camera 132 may not only be used to capture the environment features as mentioned above, but also can be used to capture the human features. These human features may be gestures, body shapes, movements of the operator or the like. To achieve these functions, the smart navigation system in this present embodiment may further includes an image database 300 and a machine learning unit 400 being capable of communicating with the controller 120. The controller 120 receives the images from the camera 132 and optionally generates a mode switch commend to change the operation mode of the AGV. Said operation modes may have 1. Follow the operator, 2. Follow a particular set of markings on the floor or walls or ceilings, 3. Follow the operator and markings simultaneously, and 4. Follow a path stored in the AGV system with the stored map using SLAM or other type of similar algorithm navigation systems.

For some embodiments of the present invention, a gesture image of the operator is captured by the camera 132, the controller 120 and the processor 110 compare characters between the captured the gesture image and images stored in the image database 300, generates the mode switch commend while the characters of the gesture image are matched to one of the images in the image database 300. To increase a calculation speed of comparing the characters of the captured gesture image and the images in the image database 300, the said characters may be vectors of the limbs, or angle between the body and the arm of the operator.

In the “Follow the operator” mode, the sensor system 130 captures images with operator therein, the controller 120 drives the processor 110 to identify the operator in the images and records the operators movements. The controller 120 and the processor 10 processes the images to determine appropriate movement of the vehicle to follow. The operator can be in front or behind the AGV, depending on the type of operation.

In the mode of “To follow the floor markings”, the camera 132 records and the controller 120 and the processor 110 identify the floor marking images thus the controller 120 may calculates desirable vehicle responses of the AGV.

In the mode of “To follow the operator in front and markings on the floor”, the camera 132 records images of the geographic area and separates the operator and floor markings and moves the vehicle accordingly. The camera 132 can also record the surrounding images and compare the image stored in the image database 300 and the controller 120 command the AGV to move in desirable directions. Depending on the desirable vehicle movement, whether as programmed by the central control, or determined by the local operator, the AGV can follow the operator then switches to floor marking either by the operator command or at certain conditions, automatically switch over by the AGV itself.

For some embodiments, the environment features may comprise status of other AGVs, status of geographic area and shape of obstacle. The status of other AGVs may be a moving speed of a AGV, a distance between the AGVs and the like. The controller 120 drives the processor 110 to calculates a detection result from the sensor system 130 to determine the moving speed of other AGV nearby,

The machine learning unit 400 is controlled by the controller 120 to identifies and records the characters of the images of the human features and the environment features for providing the some embodiment with artificial intelligence capabilities where it can learn certain patterns such as human form, gestures, other vehicles, shelves and other relevant objects in the work areas. It also recognizes floor marking including lines and barcodes and QR codes and alphanumeric signs. With these capabilities, the smart navigation system can follow the operator, the floor marking, and/or follow the prescribed path in the system by comparing the observed surroundings with the stored maps 200.

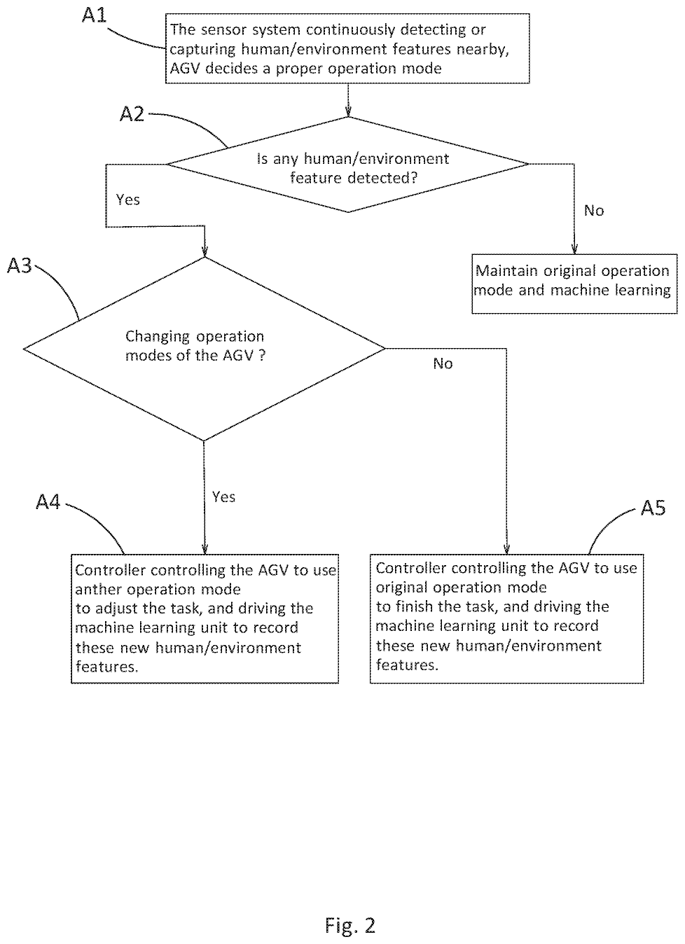

Referring to FIG. 2 which is a flow chart illustrating operation mode selection mechanism of the AGV 100 according to an embodiment of the present invention. During the maneuvering of the AGV 100 along the predetermined traveling route, step A1 is performed, where the sensor system 130 and the controller 120 continues to detect whether any environment feature or human feature is detected; if any environment/human feature is detected (step A2), step A3 is performed, the processor 110 determines whether the AGV 100 is requested to perform a new task or to perform under another operation mode, and if the AGV 100 is asked to switch to another operation mode, step A4 is performed, and if the processor 110 and the controller 120 determines that the AGV 100 should maintain the original operation mode, step A5 is performed.

As described above, the uniqueness of this system are the followings:

1. The present invention allows different navigation methods to be implemented concurrently or sequentially in a single task without hardware changes and with or without operator's input.

2. It recognizes the operator and he operator's gestures so the vehicle can switch to different navigation methods such as following the operator, following the floor marking, follow both operator and floor marking, and following prescribed paths as stored in the system.

3. The AGV can navigate the work area with minimum preparedness and is very flexible in moving around with the operator's body command and gestures

The description of the invention including its applications and advantages as set forth herein is illustrative and is not intended to limit the scope of the invention, which is set forth in the claims. Variations and modifications of the embodiments disclosed herein are possible, and practical alternatives to and equivalents of the various elements of the embodiments would be understood to those of ordinary skill in the art upon study of this patent document. For example, specific values given herein are illustrative unless identified as being otherwise, and may be varied as a matter of design consideration. Terms such as “target” and “background” or so are distinguishing terms and are not to be construed to imply an order or a specific part of the whole. These and other variations and modifications of the embodiments disclosed herein, including of the alternatives and equivalents of the various elements of the embodiments, may be made without departing from the scope and spirit of the invention, including the invention as set forth in the following claims

What is claimed is:

1. A smart navigation system of an automated guided vehicle, the smart navigation system having multiple operation modes and the automated guided vehicle switching between these operation modes comprising 1) follow operator, 2) follow markings, 3) follow operator and markings, 4) follow a map, wherein the automated guided vehicle perform the modes about following the operator by capturing images of a geographic area, the automated guided vehicle identify a operator in the images and records movements and gestures thereof to switches between the operation modes.

2. The smart navigation system of an automated guided vehicle as claimed in claim 1 having a processor, a controller connected to the processor, and a sensor system connected to the processor configured to control the automated guided vehicle between stations, wherein the sensor system detects images with human features and environment features, the human features comprises operator identity, human form, the gestures and vocal commends, the environment features comprises markings and tags, the controller operates the sensor system to continuously captures the images and the processor identify the human features and the environment features from these images, the controller switches to another operation mode while a pre-defined character in the automated guided vehicle being identified by the processor.

3. The smart navigation system of an automated guided vehicle as claimed in claim 2 having an image database being connected to the controller, wherein the image database stores characters of the human features and the environment features, the processor identifies characters in the captured images, thus the controller tracks the characters of the human features and the environment features to adjust a moving route of the automated guided vehicle.

4. The smart navigation system of an automated guided vehicle as claimed in claim 3 having a machine learning unit being connected to the controller, the machine learning unit records the characters of the detected environment features and the human features.

5. The smart navigation system of an automated guided vehicle as claimed in claim 3, wherein the automated guided vehicle is moved according to a pre-loaded map.

6. The smart navigation system of an automated guided vehicle as claimed in claim 4, the automated guided vehicle is interrupted to adjust a prior route as another new operation mode corresponding to a location of the operator and markings.
